(19) United States
(12) Patent Application Publication
(10) Pub. No.: US 2015/0227257 A1
(43) Pub. Date: Aug. 13, 2015

(54) CAPACITANCE SENSING APPARATUS AND METHOD

(71) Applicant: SAMSUNG ELECTRO-MECHANICS CO., LTD., Suwon (KR)

(72) Inventors: Hyun Suk LEE, Suwon (KR); Na Rae Park, Suwon (KR); Ji Hoon Kim, Suwon (KR)

(73) Assignee: SAMSUNG ELECTRO-MECHANICS CO., LTD., Suwon (KR)

(21) Appl. No.: 14/296,827

(22) Filed: Jun. 5, 2014

(30) Foreign Application Priority Data
Feb. 7, 2014 (KR) 10-2014-0014120

(51) Int. Cl. G06F 3/041; G06F 3/044

(52) U.S. Cl. CPC G06F 3/0418; G06F 3/044

(57) ABSTRACT

A capacitance sensing apparatus may include: a calculating unit calculating each of a plurality of variations between plurality of first and second detection signals by comparing the plurality of first detection signals detected from each of a plurality of node capacitors in accordance with applying of a first driving signal with the plurality of second detection signals detected from each of the plurality of node capacitors in accordance with applying of a second driving signal; a comparing unit determining whether or not each of the plurality of variations is within a tolerance range; and a compensation controlling unit controlling compensation of a detection capacitance storing capacitance of a corresponding node capacitor in a case in which a variation outside of the tolerance range among the plurality of variations is present, so as to allow the variation to be within the tolerance range.

### CROSS-REFERENCE TO RELATED APPLICATION

This application claims the benefit of Korean Patent Application No. 10-2014-0014120 filed on Feb. 7, 2014, with the Korean Intellectual Property Office, the disclosure of which is incorporated herein by reference.

### BACKGROUND

The present disclosure relates to a capacitance sensing apparatus and method allowing for improvements in the accuracy of coordinate calculation in the case that a touch input occurs by performing calibration in such a manner that maximum variations in capacitance in respective nodes are equal to each other.

A touch sensing apparatus such as a touchscreen, a touch pad, or the like, an input apparatus attached to a display apparatus to provide an intuitive user interface, has recently been widely used in various electronic apparatuses such as cellular phones, personal digital assistants (PDAs), navigation devices, and the like.

Touchscreens used in portable devices can be divided into resistive type touchscreens and capacitive type touchscreens, according to a method of sensing a touch input thereto. With regard thereto, capacitive type touchscreens have advantages in that they have a relatively long lifespan and various input methods and gestures may be easily used therewith, such that the use thereof has increased. Particularly, capacitive type touchscreens may easily allow for the implementation of a multi-touch interface, as compared with resistive type touchscreens, such that capacitive type touchscreens are widely used in devices such as smartphones, and the like.

Capacitive type touch sensors convert changes in capacitance occurring in touchscreens due to user touch inputs therewith into electrical signals and convert the electrical signals into digital values to thereby represent a result. In order to estimate an accurate touch position, variations in capacitance occurring due to touch inputs need to have levels greater than that of noise.

However, in a case in which the variations in capacitance are different in a plurality of respective nodes (intersection points between X electrodes and Y electrodes), a defect in which a touch input position is incorrectly calculated with incorrect coordinates may occur. Therefore, in order to improve accuracy in coordinate calculation in the case that touch inputs occur, calibration allowing for maximal variations in capacitance in the respective nodes to be equalized is required.

In order to calibrate touch variations in the respective nodes, it is necessary to change environments of a touchscreen apparatus so that changes in outputs may occur in the same manner as a form of changes in capacitance occurring in respective nodes due to a touch input.

Patent Document 1 discloses a method for performing calibration in a manner in which a test load is electrically connected to a touch sensing signal path in a gain adjusting mode. However, the method disclosed in Patent Document 1 is somewhat problematic in that the test load should be connected to all sensing circuits. In addition, the method may only allow outputs in a non-touch state to be uniform, but may not allow outputs in a touch state to be uniform. In addition, Patent Document 1 does not disclose contents in which calibration is performed by adjusting a ratio between the numbers of pulses of driving signals according to characteristics of a panel unit.

### RELATED ART DOCUMENT

(Patent Document 1) Korean Patent Laid-Open Publication No. 10-2011-0122528

### SUMMARY

An aspect of the present disclosure may provide a method allowing for improvements in the accuracy of coordinate calculation at the time of the occurrence of touch inputs by performing calibration in a case in which variations in capacitance are different in a plurality of nodes (intersection points between X electrodes and Y electrodes).

According to another aspect of the present disclosure, driving signals may be input by adjusting a ratio between the numbers of pulses according to characteristics of a panel unit, such that an output voltage may be detected in a manner similar to variations in capacitance generated at the time of an actual touch input. Therefore, calibration may be performed based on the detected output voltage so that the variations in capacitance in respective nodes of the overall panel unit are equal to each other.

According to an aspect of the present disclosure, a capacitance sensing apparatus may include: a calculating unit calculating each of a plurality of variations between plurality of first and second detection signals by comparing the plurality of first detection signals detected from each of a plurality of node capacitors in accordance with applying of a first driving signal with the plurality of second detection signals detected from each of the plurality of node capacitors in accordance with applying of a second driving signal; a comparing unit determining whether or not each of the plurality of variations is within a preset tolerance range; and a compensation controlling unit controlling compensation of a detection capacitance storing capacitance of a corresponding node capacitor in a case in which a variation outside of the tolerance range among the plurality of variations is present, so as to allow the variation to be within the tolerance range, wherein the first and second driving signals include different numbers of pulses during a preset period of time.

The capacitance sensing apparatus may further include: a selecting unit selecting a variation among the plurality of variations in a preset order, wherein the comparing unit determines whether or not the variation selected by the selecting unit is within the tolerance range.

The compensation controlling unit may transfer a selection signal to the selecting unit in a case in which the selected variation is within the tolerance range, and the selecting unit receiving the selection signal may select a subsequent variation among the plurality of variations in a preset order.

The capacitance sensing apparatus may further include: a panel unit including a plurality of driving electrodes and a plurality of sensing electrodes; and a driving circuit unit including a plurality of driving switching circuit units electrically connected to the plurality of driving electrodes, respectively, wherein the plurality of driving switching circuit units are connected to one another in parallel and are switched according to a switching control signal to apply the first and second driving signals to the plurality of driving electrodes.

The capacitance sensing apparatus may further include a detecting circuit unit including a plurality of detecting channel units electrically connected to the plurality of sensing electrodes, respectively, wherein the plurality of detecting channel units integrate capacitances of the plurality of node capacitors according to the plurality of pulses during the preset period of time to detect the plurality of first and second driving signals.

According to another aspect of the present disclosure, a capacitance sensing apparatus may include: a panel unit including a plurality of node capacitors defined at intersection points between a plurality of driving electrodes and a plurality of sensing electrodes, the plurality of respective node capacitors receiving a first driving signal and a second driving signal through the plurality of driving electrodes; a detecting circuit unit including a plurality detecting channel units electrically connected to the plurality of sensing electrodes, respectively, the plurality of detecting channel units detecting a plurality of first detection signals detected from each of the plurality of node capacitors in accordance with applying of the first driving signal and a plurality of second detection signals detected from each of the plurality of node capacitors in accordance with applying of the second driving signal; a calculating unit calculating each of a plurality of variations between the plurality of first and second detection signals to calculate average variations for the plurality of respective detecting channel units; a comparing unit determining whether or not each of the plurality of average variations is within a preset tolerance range; and a compensation controlling unit controlling compensation of a channel capacitance storing capacitance of a corresponding node capacitor in a case in which an average variation outside of the tolerance range among the plurality of average variations is present, so as to allow the average variation to be within the tolerance range, wherein the first and second driving signals include different numbers of pulses during a preset period of time.

The capacitance sensing apparatus may further include a selecting unit selecting an average variation among the plurality of average variations in a preset order, wherein the comparing unit may determine whether or not the average variation selected by the selecting unit is within the tolerance range.

The compensation controlling unit may transfer a selection signal to the selecting unit in a case in which the selected average variation is within the tolerance range, and the selecting unit receiving the selection signal may select a subsequent average variation among the plurality of average variations in a preset order.

The capacitance sensing apparatus may further include: a driving circuit unit including a plurality of driving switching circuit units electrically connected to the plurality of driving electrodes, respectively, wherein the plurality of driving switching circuit units may be connected to one another in parallel and may be switched according to a switching control signal to apply the first and second driving signals to the plurality of driving electrodes.

According to another aspect of the present disclosure, a capacitance sensing method may include: calculating each of a plurality of variations between plurality of first and second detection signals by comparing the plurality of first detection signals detected from each of a plurality of node capacitors in accordance with applying of a first driving signal with the plurality of second detection signals detected from each of the plurality of node capacitors in accordance with applying of a second driving signal; selecting a variation among the plurality of variations in a preset order; determining whether or not the selected variation is within a preset tolerance range; and controlling compensation of a detection capacitance storing capacitance of a corresponding node capacitor in a case in which a variation outside of the tolerance range among the plurality of variations is present, so as to allow the variation to be within the tolerance range, wherein the first and second driving signals include different numbers of pulses during a preset period of time.

The calculating of the plurality of variations may include performing switching according to a switching control signal to apply the first and second driving signals.

The capacitance sensing method may further include determining whether or not another variation is present within the tolerance range, wherein when it is determined that the variation to be compared is present, the selecting of the variation among the plurality of variations in the preset order may be performed.

According to another aspect of the present disclosure, a capacitance sensing method may include: calculating each of a plurality of variations between plurality of first and second detection signals by comparing the plurality of first detection signals detected from each of a plurality of node capacitors in accordance with applying of a first driving signal with the plurality of second detection signals detected from each of the plurality of node capacitors in accordance with applying of a second driving signal; calculating average variations for a plurality of respective detecting channel units based on the plurality of variations; selecting an average variation among the plurality of average variations in a preset order; determining whether or not the selected average variation is within a preset tolerance range; and controlling compensation of a channel capacitance storing capacitance of a corresponding node capacitor in a case in which the selected average variation is outside of the tolerance range, so as to allow the average variation to be within the tolerance range, wherein the first and second driving signals include different numbers of pulses during a preset period of time.

The calculating of the plurality of variations may include performing switching according to a switching control signal to apply the first and second driving signals.

The capacitance sensing method may further include determining whether or not another average variation is present within the tolerance range, wherein when it is determined that the average variation to be compared is present, the selecting of the average variation among the plurality of average variations in the preset order may be performed.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating the exterior of an electronic apparatus including a touchscreen apparatus according to an exemplary embodiment of the present disclosure;

FIG. 2 is a block diagram illustrating a capacitance sensing apparatus according to an exemplary embodiment of the present disclosure;

FIG. 3 is a circuit diagram illustrating the capacitance sensing apparatus according to an exemplary embodiment of the present disclosure;

FIG. 4 is a diagram provided to illustrate a touch sensing method according to an exemplary embodiment of the present disclosure;

FIG. 5 is a diagram illustrating a touchscreen apparatus including the capacitance sensing apparatus according to an exemplary embodiment of the present disclosure;

FIG. 6 is a flow chart provided to illustrate a capacitance sensing method according to an exemplary embodiment of the present disclosure; and

FIG. 7 is a flow chart provided to illustrate a capacitance sensing method according to another exemplary embodiment of the present disclosure.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

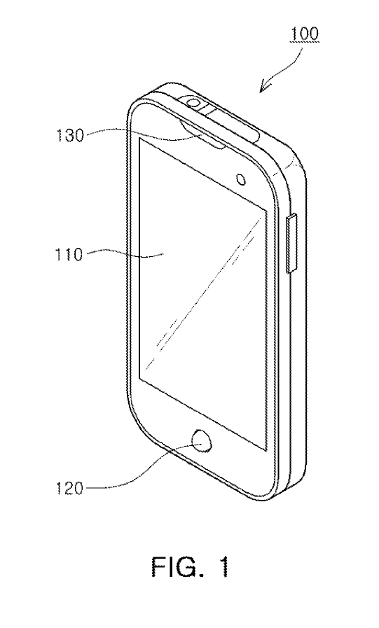

FIG. 1 is a perspective view illustrating the exterior of an electronic apparatus including a touchscreen apparatus according to an exemplary embodiment of the present disclosure. Referring to FIG. 1, an electronic apparatus 100 according to the present embodiment may include a display apparatus 110 for outputting a screen therethrough, an input unit 120, an audio unit 130 for outputting a sound, and the like, and a touchscreen apparatus integrated with the display apparatus 110.

As shown in FIG. 1, in the case of a mobile apparatus, the touchscreen apparatus is generally provided in a state in which it is integrated with the display apparatus, and needs to have high light transmissivity enough to transmit a screen displayed by the display apparatus. Therefore, the touchscreen apparatus may be implemented by forming a sensing electrode using a transparent and electrically conductive material such as indium tin oxide (ITO), indium zinc oxide (IZO), zinc oxide (ZnO), carbon nano tube (CNT), or graphene on a base substrate formed of a transparent film material such as polyethylene terephtalate (PET), polycarbonate (PC), polyethersulfone (PES), polyimide (PI), or the like. The display apparatus may have a wiring pattern disposed in a bezel region thereof, and the wiring pattern may be connected to the sensing electrode formed of the transparent and conductive material. Since the wiring pattern is visually shielded by the bezel region, it may also be formed of a metal material such as silver (Ag), copper (Cu), or the like.

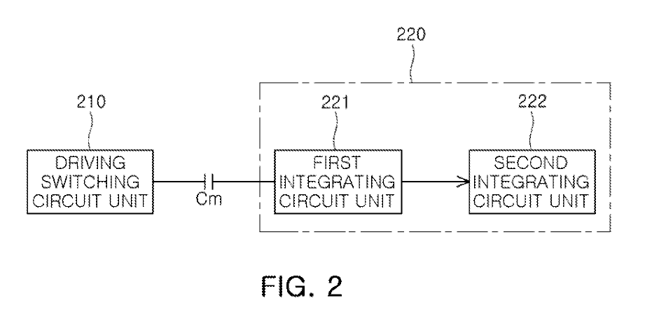

Since the touchscreen apparatus according to an exemplary embodiment of the present disclosure may be a capacitive type touchscreen apparatus, the touchscreen apparatus may include a plurality of electrodes having a predetermined pattern. In addition, the touchscreen apparatus according to an exemplary embodiment of the present disclosure may include a capacitance sensing apparatus for detecting changes in capacitance generated in the plurality of electrodes. Hereinafter, a capacitance sensing apparatus and an operation method thereof according to an exemplary embodiment of the present disclosure will be described with reference to FIGS. 2 through 5.

FIG. 2 is a block diagram illustrating a capacitance sensing apparatus according to an exemplary embodiment of the present disclosure. Referring to FIG. 2, the capacitance sensing apparatus according to the exemplary embodiment may include a driving switching circuit unit 210 and a detecting channel unit 220, and the detecting channel unit 220 may include a first integrating circuit unit 221 and a second integrating circuit unit 222. A node capacitor Cm in which changes in capacitance to be measured are generated may be connected between the driving switching circuit unit 210 and the first integrating circuit unit 221.

In FIG. 2, the node capacitor Cm may be a capacitor in which capacitance to be measured by the capacitance sensing apparatus according to the exemplary embodiment is charged. By way of example, the node capacitor Cm may have mutual capacitance generated between a plurality of electrodes included in a capacitive type touchscreen. Hereinafter, a case in which the capacitance sensing apparatus according to the exemplary embodiment detects changes in capacitance generated in the capacitive type touchscreen is presented for convenience of explanation. In this case, it may be assumed that the node capacitor Cm is a node capacitor in which charges are charged and from which charges are discharged by the changes in mutual capacitance generated in intersection points between the plurality of electrodes.

The driving switching circuit unit 210 may generate a predetermined driving signal for charging the charges in the node capacitor Cm and supply the generated driving signal to the node capacitor Cm. The driving signal may be a square wave signal having a pulse form and have a predetermined frequency.

The detecting channel unit 220 may include the first integrating circuit unit 221 and the second integrating circuit unit 222 to generate an output voltage from an amount of charges charged in the node capacitor Cm or discharged from the node capacitor Cm.

The first integrating circuit unit 221 may include one or more capacitors receiving the charges charged in the node capacitor Cm to be charged or discharged. The first integrating circuit unit 221 may generate an output voltage from an amount of charges charged in the node capacitor or discharged from the node capacitor.

The second integrating circuit unit 222 may include one or more capacitors receiving the charges charged in the capacitor included in the first integrating circuit unit 221, to be charged or discharged. The second integrating circuit unit 222 may generate an output voltage from an amount of charges charged in the capacitor or discharged from the capacitor.

Each of the first and second integrating circuit units 221 and 222 may include a plurality of switches. Operations of the plurality of switches may be controlled to control operations of the first and second integrating circuit units 221 and 222.

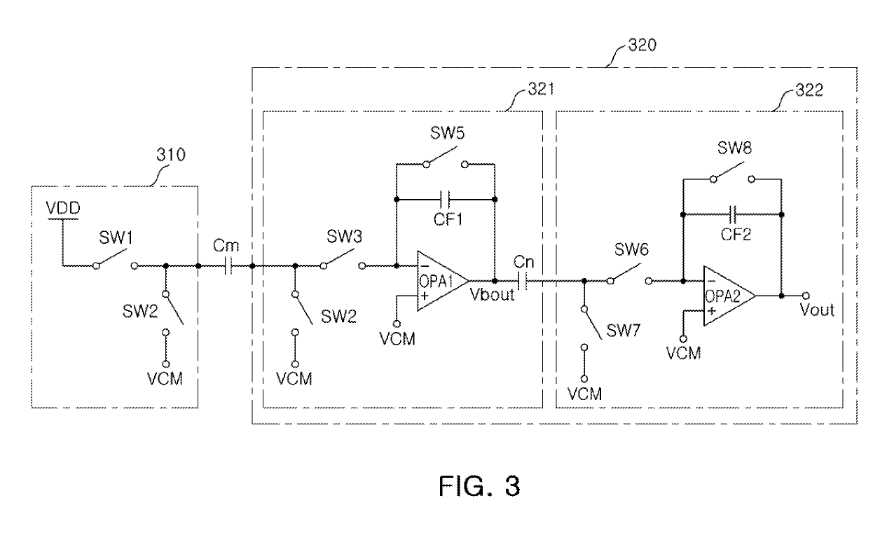

FIG. 3 is a circuit diagram illustrating the capacitance sensing apparatus according to an exemplary embodiment of the present disclosure.

Referring to FIG. 3, the capacitance sensing apparatus according to the exemplary embodiment may include a driving switching circuit unit 310 and a detecting channel unit 320, and the detecting channel unit 320 may include a first integrating circuit unit 321 and a second integrating circuit unit 322.

First, the driving switching circuit unit 310 may include two switches, that is, a first switch SW1 and a second switch SW2. Here, the first switch SW1 may be connected to a node supplying a voltage VDD and a first node of a node capacitor Cm. Meanwhile, the second switch SW2 may be connected to a node supplying a common voltage VCM and the first node of the node capacitor Cm. In a case in which the first switch SW1 is turned on (closed), charges may be charged in the node capacitor Cm due to the voltage VDD, and in a case in which the second switch SW2 is turned on, charges charged in the node capacitor Cm may be discharged. As a result, the first switch SW1 and the second switch SW2 may be operated at different turn-on times.

Meanwhile, the first integrating circuit unit 321 may be connected to a second node of the node capacitor Cm. The first integrating circuit unit 321 may include a first operational amplifier OPA1, a first capacitor CF1, a detecting capacitor Cn, a third switch SW3, a fourth switch SW4, a fifth switch SW5, and the like. During a time in which the first switch SW1 and the second switch SW2 are turned on and turned off, the third switch SW3 and the fourth switch SW4 may be turned on and turned off. In addition, the third switch SW3 and the fourth switch SW4 may be operated at different turn-on times.

The charges may be supplied to the first capacitor CF1 of the first integrating circuit unit 321 through the node capacitor Cm by turn-on/off operations of the first switch SW1 and the third switch SW3. During a time in which the fifth switch SW5 connected to the first capacitor CF1 of the first integrating circuit unit 321 in parallel is turned off, the charges charged in the node capacitor Cm may be transferred to the first capacitor CF1, and during a time in which the fifth switch SW 5 is turned on, the first operational amplifier OPA1 may be reset. Here, an output voltage Vbout of the first operational amplifier OPA1 generated due to the charges charged in the first capacitor CF1 may be determined to be represented by the following Equation 1.

$${V}_{bout} = \frac{Cm}{CF 1} \times {V}_{DD} \qquad [ Equation 1 ]$$

As seen from Equation 1, the output voltage Vbout of the first integrating circuit unit 321 may be determined according to a capacitance ratio between the node capacitor Cm and the first capacitor CF1.

Meanwhile, the second integrating circuit unit 322 may be connected to a second node of the detecting capacitor Cn included in the first integrating circuit unit 321. The second integrating circuit unit 322 may include a second operational amplifier OPA2, a second capacitor CF2, a sixth switch SW6, a seventh switch SW7, an eighth switch SW8, and so on. The sixth switch SW6 may be operated in the same period of time as that of the first switch SW1 of the driving switching circuit unit 310, and the seventh switch SW7 may be operated in the same period of time as that of the second switch SW2 of the driving switching circuit unit 310. The sixth switch SW6 may have the same period of time as that of the first switch SW1 and the seventh switch SW7 may also have the same period of time as that of the second switch SW2. In addition, the sixth switch SW6 and the seventh switch SW7 may be operated at different turn-on times.

During a time in which the sixth switch SW6 is turned on and the seventh switch SW7 and the eighth switch SW8 are turned off, the charges charged in the capacitor Cn of the first integrating circuit unit 321 may be transferred to the second capacitor CF2, and during a time in which the eighth switch SW8 is turned on, the second operational amplifier OPA2 may be reset.

As a result, the charges charged in the detecting capacitor Cn may be input to the second integrating circuit unit 322, and an output voltage Vout of the second integrating circuit unit 322 may be determined to be represented by the following Equation 2.

$${V}_{out} = 2 \times \frac{Cm}{CF 1} \times \frac{Cn}{CF 2} \times {V}_{DD} \times N \qquad [ Equation 2 ]$$

Here, N is the number of pulses of a driving signal input by the driving switching circuit unit 310. The second integrating circuit unit 322 may receive the output voltage of the first integrating circuit unit 321 and integrate the received output voltage by a turn-off period of the eighth switch SW8. In addition, a value of the common voltage VCM may be set to VDD/2.

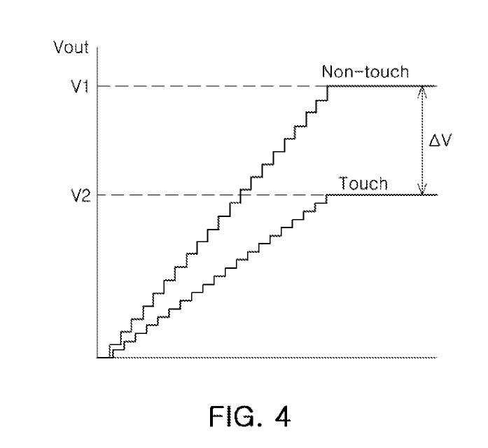

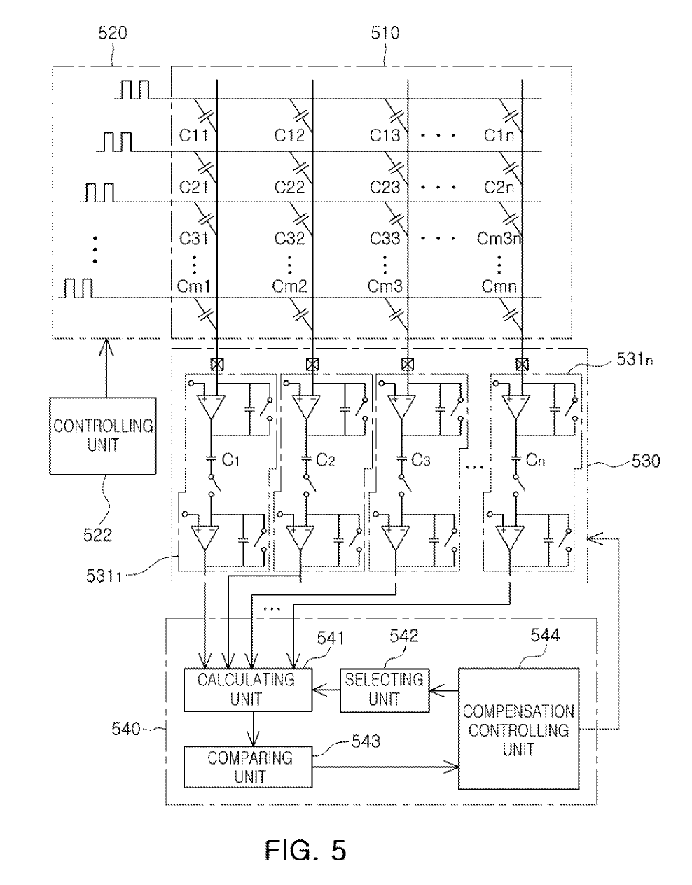

FIG. 4 is a diagram provided to illustrate a touch sensing method according to an exemplary embodiment of the present disclosure. FIG. 5 is a diagram illustrating a touchscreen apparatus including the capacitance sensing apparatus according to an exemplary embodiment of the present disclosure.

Referring to FIGS. 3 and 4, in a general touch sensing method, the output Vout of the second integrating circuit unit 322 is shown. Particularly, FIG. 4 is a graph simply illustrating integration results of a case in which a touch input is not present (Non-Touch) and a case in which the touch input is present (Touch).

Here, variation ΔV is defined as a difference between the output voltages of a case in which the touch input is not present (Non-Touch, V1) and a case in which the touch input is present (Touch, V2). In the general touch sensing method, an amount of changes in capacitance may correspond to the variation ΔV, and in a case in which the variation ΔV is different for each of a plurality of nodes (intersection points of an X electrode and a Y electrode), a defect in which a touch position is calculated by incorrect coordinates may occur.

Referring to FIG. 5, the touchscreen apparatus according to the exemplary embodiment may include a panel unit 510, a driving circuit unit 520, a controlling unit 522, a detecting circuit unit 530, and a capacitance sensing apparatus 540.

The panel unit 510 may include a plurality of driving electrodes extended in a first axial direction, that is, a horizontal direction of FIG. 5 and a plurality of sensing electrodes extended in a second axial direction, that is, a vertical direction of FIG. 5, intersecting with the first axial direction, and changes in capacitance C11 to Cmn are generated in intersection points between the driving electrodes and the sensing electrodes. The changes in capacitance C11 to Cmn generated at the intersection points between the driving electrodes and the sensing electrodes may be changes in mutual capacitance generated by driving signals applied to the driving electrodes by the driving circuit unit 520. Meanwhile, the driving circuit unit 520, the detecting circuit unit 530, the controlling unit 522, and the capacitance sensing apparatus 540 may be implemented as a single integrated circuit (IC).

The driving circuit unit 520 may apply predetermined driving signals to the plurality of driving electrodes. The driving signals may be square wave signals, sine wave signals, triangle wave signals, or the like, having a predetermined period and amplitude and be sequentially applied to each of the plurality of driving electrodes.

According to an exemplary embodiment of the present disclosure, the driving circuit unit 520 may have a plurality of driving switching circuit units electrically connected to the plurality of driving electrodes, respectively, and the plurality of driving switching circuit units may be connected to one another in parallel and be switched according to a switching control signal to apply first and second driving signals to the plurality of respective driving electrodes.

According to an exemplary embodiment of the present disclosure, the plurality of driving switching circuit units may be switched according to the switching control signal to sequentially apply the first driving signal to the plurality of driving electrodes. That is, the first driving signal, which has the same on/off duty ratio and is delayed by a preset time interval, may be sequentially applied to the plurality of driving electrodes. In addition, after the first driving signal is applied and a preset time is elapsed, the second driving signal, which have the same an on/off duty ratio and is delayed by a preset time interval, may be sequentially applied to the plurality of driving electrodes.

The controlling unit 522 may control the driving circuit unit 520 to apply a first driving signal N1 and a second driving signal N2 to the plurality of driving electrodes of the panel unit 510 according to an exemplary embodiment of the present disclosure. The first and second driving signals may include different numbers of a plurality of pulses during a preset period of time. The preset period of time may be set to be the same as the turn-off time of the eighth switch SW8.

As an example, the controlling unit 522 may control the driving circuit unit 520 to sequentially apply the first driving signal N1 including 100 pulses to the plurality of driving electrodes within a preset period of time and to sequentially apply the second driving signal N2 including 85 pulses to the plurality of driving electrodes within the same period of time as the preset period of time after a predetermined period of time has elapsed subsequently to the applying of the first driving signal N1.

In order to calibrate variations in capacitance for the respective nodes, it is necessary to change environments of the touchscreen apparatus so that changes in outputs may occur in the same manner as a form of changes in capacitance occurring in respective nodes due to touch inputs. To this end, according to an exemplary embodiment of the present disclosure, by applying individual characteristics of touch panels used in the panel unit 510, the second driving signal N2 may have a pulse number ratio adjusted in relation to the first driving signal N1.

Referring to FIG. 4, output voltages of the detecting circuit unit 530 according to the first driving signal N1 and the second driving signal N2 may correspond to a case in which the touch input is not present (Non-Touch, V1) and a case in which the touch input is present (Touch, V2), respectively, in a general capacitance apparatus.

The detecting circuit unit 530 may include the detecting channel unit for detecting the changes in capacitance C11 to Cmn from the plurality of sensing electrodes. Ina case in which the driving signals are sequentially applied to the plurality of driving electrodes, since the detecting channel unit may sequentially detect the changes in capacitance C11 to Cmn from n sensing electrodes, the detecting channel unit may be formed of a plurality of detecting channel unit 531₁, . . . , 531ₙ corresponding to the number n of sensing electrodes.

Referring to FIGS. 3 and 5, an optional detecting channel unit 320 or 531ₙ may include the detecting capacitor Cn having a predetermined capacitance. Cm may be any node capacitor among a plurality of node capacitors C1n, C2n, . . . , Cmn, and Cn may be a separate detecting capacitor corresponding to Cm to store capacitance of the node capacitor.

In addition, according to an exemplary embodiment of the present disclosure, although Cn among the detecting capacitors of FIG. 5 is shown as Cn in FIG. 5, it may sequentially store the changes in capacitance of the plurality of node capacitors C1n, C2n, . . . , Cmn. To this end, the detecting capacitor Cn having m capacitors connected to one another in parallel to correspond to the plurality of node capacitors C1n, C2n, . . . , Cmn may be provided. In addition, the detecting capacitor Cn of FIG. 5 may be implemented as a variable capacitor to sequentially store the changes in capacitance of the plurality of node capacitors C1n, C2n, . . . , Cmn.

Therefore, each of the plurality of detecting capacitors C1, . . . , Cn may include a plurality of m capacitors connected to one another in parallel and may be switched by a separate switch to thereby store the changes in capacitance of the plurality of node capacitors C11 to Cmn, respectively.

In addition, according to an exemplary embodiment of the present disclosure, each of the detecting channel units 320 and 531ₙ of FIG. 5 may include the detecting capacitors C1, C2, . . . , Cn, respectively, having a predetermined capacitance. In this case, the detecting capacitors C1, C2, . . . , Cn are defined as channel capacitors.

Comparing the capacitance sensing apparatus shown in FIGS. 2 and 3 and the touchscreen apparatus shown in FIG. 5 with each other, any node capacitor among the plurality of node capacitors C11 to Cmn of FIG. 5 may correspond to the node capacitor Cm of FIGS. 2 and 3. In addition, the driving circuit unit 520 of FIG. 5 may include a plurality of driving switching circuit units, and the respective driving switching circuit units may correspond to the driving switching circuit units 220 and 320 of FIGS. 2 and 3.

In addition, the plurality of detecting channel units 531₁, . . . , 531ₙ of FIG. 5 may correspond to the detecting channel units 210 and 310 of FIGS. 2 and 3, respectively, and may perform the same functions as those of the detecting channel units 210 and 310. Any detecting capacitor among the plurality of detecting capacitors C1 to Cn of FIG. 5 may correspond to the detecting capacitor Cn of FIGS. 2 and 3.

The capacitance sensing apparatus 540 may include an calculating unit 541, a selecting unit 542, a comparing unit 543, and a compensation controlling unit 544. In a general case in which the touch input is present, the touchscreen apparatus may detect a variation ΔV to determine whether or not the touch input is present and the touch position.

According to an exemplary embodiment of the present disclosure, in a case in which the variation ΔV is outside of a predetermined tolerance range, calibration capable of improving accuracy of a touch coordinate calculation may be performed. The calibration may be defined as a compensation method allowing the maximum variation in capacitances detected from the plurality of node capacitors C11 to Cmn to be within a predetermined range.

First, the calibration may be started with the first driving signal N1 being sequentially applied to the plurality of driving electrodes by the driving circuit unit 520. The sensing circuit unit 530 may detect the changes in capacitance in the plurality of node capacitors C11 to Cmn from the plurality of sensing electrodes and transfer the detected changes in capacitance to the capacitance sensing apparatus 540.

Referring to FIG. 4, the change in capacitance of the node capacitor Cm according to the first driving signal N1 may correspond to a case in which the touch input is not present (Non-Touch). Therefore, the output of the second integrating circuit unit 322 may correspond to an output voltage V1. According to an exemplary embodiment of the present disclosure, the output voltage V1 may be defined as a first detection signal (Touch Scan).

Next, the second driving signal N2 may be sequentially applied to the plurality of driving electrodes by the driving circuit unit 520. The sensing circuit unit 530 may detect the change in capacitance of the node capacitor Cm from the sensing electrode and transfer the detected capacitance change to the capacitance sensing apparatus 540.

Referring to FIG. 4, the change in capacitance of the node capacitor Cm according to the second driving signal N2 may correspond to a case in which the touch input is present (Touch). Therefore, the output of the second integrating circuit unit 322 may correspond to an output voltage V2. According to an exemplary embodiment of the present disclosure, the output voltage V2 may be defined as a second detection signal (Touch Scan).

Therefore, a plurality of first detection signals detected from each of the plurality of node capacitors C11 to Cmn in accordance with the applying of the first driving signal and a plurality of second detection signals detected from each of the plurality of node capacitors C11 to Cmn in accordance with the applying of the second driving signal may be transferred to the capacitance sensing apparatus 540.

The calculating unit 541 may receive the plurality of first detection signals V1 and the plurality of second detection signals V2 and may calculate a plurality of variations ΔV according to the following Equation 3.

$$Δ V = {V}_{1} - {V}_{2} = 2 \times \frac{Cm}{CF 1} \times \frac{Cn}{CF 2} \times {V}_{DD} \times Δ N \qquad [ Equation 3 ]$$

The variations ΔV may be calculated by the calculating unit 541 for each of the plurality of node capacitors C11 to Cmn and a plurality of variations ΔV11 to ΔVmn, which are calculated results, may be stored in the calculating unit 541.

In addition, the calculating unit 541 may calculate an average variation ΔVo based on the plurality of stored variations ΔV11 to ΔVmn. According to an exemplary embodiment of the present disclosure, an average calculation may be performed on the variations ΔV corresponding to node capacitors positioned in the center region of the panel, such that the average variation ΔVo may be calculated and used. In considering characteristics of the panel, corner regions of the panel may have discontinuity in the nodes and exhibit somewhat different characteristics from the nodes in the center region. A boundary between the center region and the corner regions may be arbitrarily set by a user in consideration of characteristics of the panel.

In addition, according to an exemplary embodiment of the present disclosure, the calculating unit 541 may perform the average calculation based on the plurality of stored variations ΔV11 to ΔVmn to calculate average variations ΔV1 to ΔVn for each of the plurality of detecting channel units 531₁, . . . , 531ₙ. An average variation ΔVy may be calculated as much as the number n of detecting channel units 531₁, . . . , 531ₙ.

According to an exemplary embodiment of the present disclosure, the selecting unit 542 may select one variation ΔV among the plurality of variations ΔV11 to ΔVmn in a preset order. In addition, according to an exemplary embodiment of the present disclosure, the selecting unit 542 may select one average variation ΔVy among the plurality of average variations ΔV1 to ΔVn in a preset order.

The comparing unit 543 may determine whether or not the selected variation ΔV or average variation ΔVy is within a preset tolerance range. Here, as an example, the tolerance range may be set to be within 10% of the average variation ΔVo. The tolerance range needs to be set to be larger than noise displacement in order to prevent a problem in which the output is not stabilized due to noise at a time in which the calibration is performed, and needs to be set so that a position estimating error occurs within 1 mm at the time in which a position estimating algorithm is applied.

In a case in which the selected variation ΔV or average variation ΔVy is larger or less than the preset tolerance range, the comparing unit 543 may transfer a deviation compensating signal to the compensation controlling unit 544. Meanwhile, in a case in which the selected variation ΔV is within a predetermined deviation range of the entire average variation ΔVo, the comparing unit 543 may transfer a holding signal to the compensation controlling unit 544.

The compensation controlling unit 544 receiving the deviation compensating signal may control compensation of a detection capacitance Cn storing the capacitance of the corresponding node capacitor Cm so that the corresponding variation ΔV is within the tolerance range. According to another exemplary embodiment of the present disclosure, the compensation controlling unit 544 receiving the deviation compensating signal may control compensation of a channel capacitance Cn storing the capacitance of the corresponding node capacitor Cm so that the average variation ΔVy is within the tolerance range. By adjusting the capacitance of the corresponding detection capacitance Cn, the selected variation ΔV or average variation ΔVy may be compensated to be within the tolerance range.

When the compensation of the detection capacitance Cn or the channel capacitance Cn is completed, the compensation controlling unit 544 may determine whether or not another variation ΔV or average variation ΔVy is present within the tolerance range. In addition, the compensation controlling unit 544 receiving the holding signal may determine whether or not another variation ΔV or average variation ΔVy is present within the tolerance range.

In a case in which another variation ΔV or average variation ΔVy is present within the tolerance range, the compensation controlling unit 544 may transfer a selection signal to the selecting unit 542. The selecting unit 542 receiving the selection signal may select a subsequent variation ΔV or a subsequent average variation ΔVy among the plurality of variations ΔV11 to ΔVmn or the plurality of average variations ΔVy in a preset order.

In a case in which another variation ΔV or average variation ΔVy is not present within the tolerance range, the compensation controlling unit 544 may terminate the execution of calibration. That is, capacitances of the respective detecting capacitors C11 to Cmn corresponding to the plurality of node capacitors C11 to Cmn may be differently adjusted so that the maximum variation of the capacitance detected from all of the node capacitors C11 to Cmn of the panel unit 510 is within the predetermined deviation range, that is, the tolerance range.

The calibration may be performed simultaneously with the detection of capacitance for determining the sensing of touch inputs in a general touchscreen apparatus. However, the calibration may be performed only in a case in which the variation ΔV deviates from the predetermined tolerance range, and in a case in which all variations ΔV are within the tolerance range ΔVo, a calibration routine may be terminated.

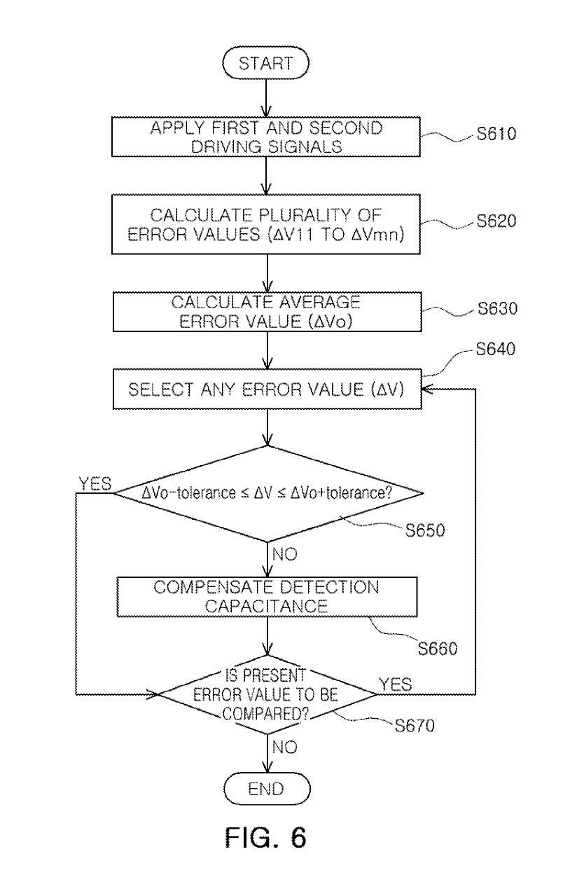

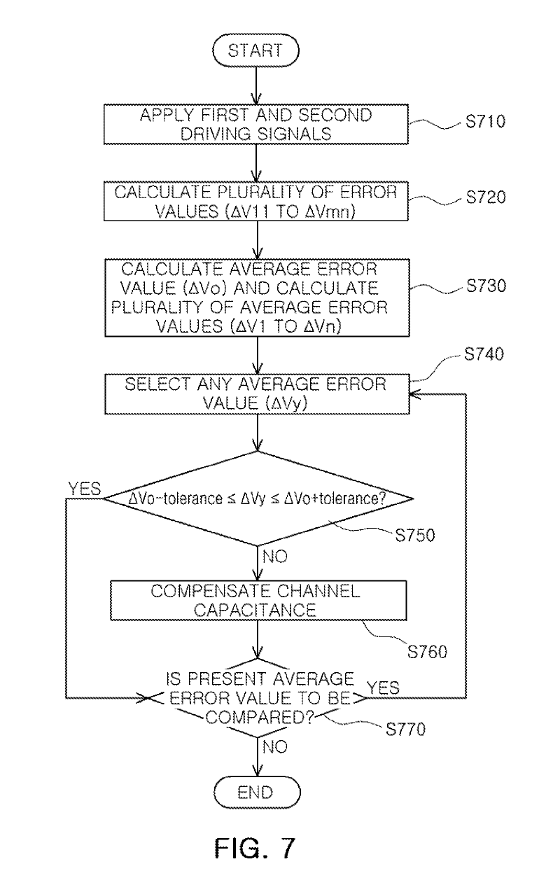

FIG. 6 is a flow chart provided to illustrate a capacitance sensing method according to an exemplary embodiment of the present disclosure. FIG. 7 is a flow chart provided to illustrate a capacitance sensing method according to another exemplary embodiment of the present disclosure.

First, the method may be started with the first driving signal N1 and the second driving signal N2 being sequentially applied to the plurality of driving electrodes by the driving circuit unit 520 (S610 and S710). The sensing circuit unit 530 may detect the plurality of first detection signals V1 and the plurality of second detection signals V2 corresponding to the changes in capacitance of the plurality of node capacitors C11 to Cmn and transfer the detected signals to the calculating unit 541.

The calculating unit 541 may receive the plurality of first detection signals V1 and the plurality of second detection signals V2 and may calculate the plurality of variations ΔV11˜ΔVmn (S620 and S720). The plurality of variations ΔV11˜ΔVmn, which are calculation results, may be stored in the calculating unit 541.

In addition, the calculating unit 541 may calculate the average variation ΔVo based on the plurality of stored variations ΔV11 to ΔVmn (S630). Meanwhile, according to another exemplary embodiment of the present disclosure, the calculating unit 541 may perform the average calculation based on the plurality of stored variations ΔV11 to ΔVmn other than the average variation ΔVo to calculate average variations ΔV1 to ΔVn for each of the plurality of detecting channel units 531₁, . . . , 531ₙ (S730). The average variation ΔVy may be calculated as much as the number n of detecting channel units 531₁, . . . , 531ₙ.

Next, according to an exemplary embodiment of the present disclosure, the selecting unit 542 may select one variation ΔV among the plurality of variations Δ_{V11} to Δ∇ₘₙ in a preset order (S640). In addition, according to another exemplary embodiment of the present disclosure, the selecting unit 542 may select one average variation ΔVy among the plurality of average variations ΔV1 to ΔVn in a preset order (S740).

Next, the comparing unit 543 may determine whether or not the selected variation ΔV or average variation ΔVy is within a preset tolerance range (S650 and S750). Here, the tolerance range may be set to the average variation ΔVo.

Here, in a case in which the selected variation ΔV or average variation ΔVy is greater or less than the preset tolerance range (No in S650 and S750), the comparing unit 543 may transfer the deviation compensating signal to the compensation controlling unit 544. Meanwhile, in a case in which the selected variation ΔV is within a predetermined deviation range of the entire average variation ΔVo (Yes in S650 and S750), the comparing unit 543 may transfer a holding signal to the compensation controlling unit 544.

The compensation controlling unit 544 receiving the deviation compensating signal may control compensation of the detection capacitance Cn storing the capacitance of the corresponding node capacitor Cm so that the corresponding variation ΔV is within the tolerance range (S660). According to another exemplary embodiment of the present disclosure, the compensation controlling unit 544 receiving the deviation compensating signal may control compensation of the channel capacitance Cn storing the capacitance of the corresponding node capacitor Cm so that the average variation ΔVy is within the tolerance range (S760).

When the compensation of the detection capacitance Cn or the channel capacitance Cn is completed, the compensation controlling unit 544 receiving the holding signal may determine whether another variation ΔV or average variation ΔVy is present within the tolerance range (S670 and S770).

In a case in which another variation ΔV or average variation ΔVy is present within the tolerance range (Yes in S670 and S770), the compensation controlling unit 544 may transfer a selection signal to the selecting unit 542.

In a case in which another variation ΔV or average variation ΔVy is not present within the tolerance range (No in S670 and S770), the compensation controlling unit 544 may terminate the execution of the calibration.

That is, the capacitances of the respective detecting capacitors C11 to Cmn corresponding to the plurality of node capacitors C11 to Cmn may be differently adjusted so that the maximum variation of the capacitance detected from all of the node capacitors C11 to Cmn of the panel unit 510 is within the predetermined deviation range, that is, the tolerance range.

As set forth above, according to exemplary embodiments of the present disclosure, driving signals may be input by adjusting a ratio between the numbers of pulses according to characteristics of a panel unit, such that variations in capacitance generated at the time of actual touch inputs may be uniformed. In addition, integral pulses, which have digital values, have no deviation even in a case in which the number of integral pulses is varied, such that the integral pulses may be more suitable for calibration.

While exemplary embodiments have been shown and described above, it will be apparent to those skilled in the art that modifications and variations could be made without departing from the spirit and scope of the present disclosure as defined by the appended claims.

What is claimed is:

1. A capacitance sensing apparatus comprising:
a calculating unit calculating each of a plurality of variations between plurality of first and second detection signals by comparing the plurality of first detection signals detected from each of a plurality of node capacitors in accordance with applying of a first driving signal with the plurality of second detection signals detected from each of the plurality of node capacitors in accordance with applying of a second driving signal;
a comparing unit determining whether or not each of the plurality of variations is within a tolerance range; and
a compensation controlling unit controlling compensation of a detection capacitance storing capacitance of a corresponding node capacitor in a case in which a variation outside of the tolerance range among the plurality of variations is present, so as to allow the variation to be within the tolerance range,
wherein the first and second driving signals include different numbers of pulses during a period of time.

2. The capacitance sensing apparatus of claim 1, further comprising a selecting unit selecting a variation among the plurality of variations in a order,
wherein the comparing unit determine whether or not the variation selected by the selecting unit is within the tolerance range.

3. The capacitance sensing apparatus of claim 2, wherein the compensation controlling unit transfers a selection signal to the selecting unit in a case in which the selected variation is within the tolerance range, and
the selecting unit receiving the selection signal selects a subsequent variation among the plurality of variations in a order.

4. The capacitance sensing apparatus of claim 1, further comprising:
a panel unit including a plurality of driving electrodes and a plurality of sensing electrodes; and
a driving circuit unit including a plurality of driving switching circuit units electrically connected to the plurality of driving electrodes, respectively,
wherein the plurality of driving switching circuit units are connected to one another in parallel and are switched according to a switching control signal to apply the first and second driving signals to the plurality of driving electrodes.

5. The capacitance sensing apparatus of claim 4, further comprising a detecting circuit unit including a plurality of detecting channel units electrically connected to the plurality of sensing electrodes, respectively,
wherein the plurality of detecting channel units integrate capacitances of the plurality of node capacitors according to the plurality of pulses during the period of time to detect the plurality of first and second driving signals.

6. A capacitance sensing apparatus comprising:
a panel unit including a plurality of node capacitors defined at intersection points between a plurality of driving electrodes and a plurality of sensing electrodes, the plurality of respective node capacitors receiving a first driving signal and a second driving signal through the plurality of driving electrodes;
a detecting circuit unit including a plurality detecting channel units electrically connected to the plurality of sensing electrodes, respectively, the plurality of detecting channel units detecting a plurality of first detection signals detected from each of the plurality of node capacitors in accordance with applying of the first driving signal and a plurality of second detection signals detected from each of the plurality of node capacitors in accordance with applying of the second driving signal;
a calculating unit calculating each of a plurality of variations between the plurality of first and second detection signals to calculate average variations for the plurality of respective detecting channel units;
a comparing unit determining whether or not each of the plurality of average variations is within a tolerance range; and
a compensation controlling unit controlling compensation of a channel capacitance storing capacitance of a corresponding node capacitor in a case in which an average variation outside of the tolerance range among the plurality of average variations is present, so as to allow the average variation to be within the tolerance range,
wherein the first and second driving signals include different numbers of pulses during a period of time.

7. The capacitance sensing apparatus of claim 6, further comprising a selecting unit selecting an average variation among the plurality of average variations in a order,
wherein the comparing unit determines whether or not the average variation selected by the selecting unit is within the tolerance range.

8. The capacitance sensing apparatus of claim 7, wherein the compensation controlling unit transfers a selection signal to the selecting unit in a case in which the selected average variation is within the tolerance range, and
the selecting unit receiving the selection signal selects a subsequent average variation among the plurality of average variations in a order.

9. The capacitance sensing apparatus of claim 6, further comprising a driving circuit unit including a plurality of driving switching circuit units electrically connected to the plurality of driving electrodes, respectively,
wherein the plurality of driving switching circuit units are connected to one another in parallel and are switched according to a switching control signal to apply the first and second driving signals to the plurality of driving electrodes.

10. A capacitance sensing method comprising:
calculating each of a plurality of variations between plurality of first and second detection signals by comparing the plurality of first detection signals detected from each of a plurality of node capacitors in accordance with applying of a first driving signal with the plurality of second detection signals detected from each of the plurality of node capacitors in accordance with applying of a second driving signal;
selecting a variation among the plurality of variations in a order;
determining whether or not the selected variation is within a tolerance range; and
controlling compensation of a detection capacitance storing capacitance of a corresponding node capacitor in a case in which a variation outside of the tolerance range among the plurality of variations is present, so as to allow the variation to be within the tolerance range,
wherein the first and second driving signals include different numbers of pulses during a period of time.

11. The capacitance sensing method of claim 10, wherein the calculating of the plurality of variations includes performing switching according to a switching control signal to apply the first and second driving signals.

12. The capacitance sensing method of claim 11, further comprising determining whether or not another variation is present within the tolerance range,
wherein when it is determined that the variation to be compared is present, the selecting of the variation among the plurality of variations in the order is performed.

13. A capacitance sensing method comprising:
calculating each of a plurality of variations between plurality of first and second detection signals by comparing the plurality of first detection signals detected from each of a plurality of node capacitors in accordance with applying of a first driving signal with the plurality of second detection signals detected from each of the plurality of node capacitors in accordance with applying of a second driving signal;
calculating average variations for a plurality of respective detecting channel units based on the plurality of variations;
selecting an average variation among the plurality of average variations in a order;
determining whether or not the selected average variation is within a tolerance range; and
controlling compensation of a channel capacitance storing capacitance of a corresponding node capacitor in a case in which the selected average variation is outside of the tolerance range, so as to allow the average variation to be within the tolerance range,
wherein the first and second driving signals include different numbers of pulses during a period of time.

14. The capacitance sensing method of claim 13, wherein the calculating of the plurality of variations includes performing switching according to a switching control signal to apply the first and second driving signals.

15. The capacitance sensing method of claim 13, further comprising determining whether or not another average variation is present within the tolerance range,
wherein when it is determined that the average variation to be compared is present, the selecting of the average variation among the plurality of average variations in the order is performed.
